(19) United States
(12) Patent Application Publication
(10) Pub. No.: US 2007/0074357 A1
(43) Pub. Date: Apr. 5, 2007

(54) Truck terminal snow screed portable structure

(76) Inventor: Myron S. Reed, Freehold, NJ (US)

Correspondence Address: Charles I. Brodsky, 2 Bucks Lane, Marlboro, NJ, 07746, US

(21) Appl. No.: 11/241,381

(22) Filed: Oct. 3, 2005

(51) Int. Cl. B60S 3/04

(52) U.S. Cl. 15/3; 15/DIG. 2

(57) ABSTRACT

A snow remover for the roofs of trucks and tractor trailers in which a structure of two vertical supports and a cross piece spanning them in supporting a plow rests upon a connected base plate provided with pairs of pockets on each side of the structure to allow for its lifting by a pair of forklifts operating in tandem and moving to a truck terminal access lane when snow build-up removal is warranted, and thereafter moved into storage.

### CROSS-REFERENCE TO RELATED APPLICATIONS

NONE

### Statement Regarding Federally Sponsored Reserch or Development

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to the removal of snow from vehicle roofs, in general, and to the removal of snow from the roofs of trucks and tractor-trailers, in particular.

2. Description of the Related Art

As will be appreciated, there exist a number of design constructions proposed in the past for dealing with the build-up of snow on vehicle roofs. Typical of these are:
1. U.S. Pat. No. 6,654,978 describes a snow removing device anchored to the ground and includes a manually wound drum for operating winch. The invention is concerned with a substantially resilient skirt which does the scraping of snow, and a manner of controlling the pressure which is exerted on the roof.
2. U.S. Pat. No. 1,492,894 just shows a “duster” for brushing the top of a car.
3. U.S. Pat. No. 1,611,273 shows a scraper suspended at the entrance of a garage into which the vehicle is driven for having the dust collected by an oil treated skirt.
4. U.S. Pat. No. 5,989,356 shows a snow scraping apparatus in the nature of a roller. The height adjustment is accomplished by a hydraulic circuit, with the entire arrangement being secured to the ground.
5. U.S. Pat. No. 6,453,500 discloses a vehicle show removal system which dispenses de-icer fluid from the cross-member for de-icing hard bonded ice, and could also be wash down fluid for washing dirt from the roof. Snow chutes divert the melting snow away. The raising and lowering of the crossbar is accomplished by an automatic sensor, although in other embodiments, it can be manipulated by a user.
6. German Patent DE-197-12-648 describes a truck with a flexible covered roof which could be inflated in a direction to cause collected water and snow to run off.

As another one, U.S. Pat. No. 5,802,654 additionally describes, trucking companies spend considerable money to clear snow from the roofs of trailers after every major snow storm. Such effort not only costs money but requires significant time—so that the operation of the rigs of a large fleet can be delayed significantly after a snow storm. Furthermore, since the snow removal has oftentimes been done manually by workers shoveling from atop the trailers, employers and insurance companies are very concerned about the danger of such workers slipping and falling from the typically 13 foot high trailer roofs.

U.S. Pat. No. 5,802,654 goes on to describe a snow plow arrangement for the roofs of trucks and trailers which functions by having the vehicle move under the snow plow arrangement which is embedded in the ground. The apparatus of the invention is a bridge-like structure with two vertical “I” beams and an upper cross piece which is used to support a vertically adjustable bar. The adjustable bar has a wedge-shaped plow formed on its lower edge, to which is attached a stiff rubber blade; when a snow covered truck or trailer moves under the properly positioned plow, the snow is pushed off the top of the vehicle by the-blade and onto the ground. In the preferred embodiment shown,-raising the plow is accomplished by a winch on the upper cross piece which reels in a chain from which the plow is hung. To lower the plow, the winch is released and braked, and the chain is pulled out slowly by the weight of the plow.

As will be appreciated by those skilled in the art, there are several inherent problems with this type of snow removal apparatus:
a. First, like the constructions set out in U.S. Pat. Nos. 6,654,978 and 6,453,500, its frame is “stationary”, with the vertical supports being free-standing “I” beams embedded in concrete. For trailers and tractors of typical 70+ foot length, the truck terminal access length then becomes almost permanently tied up all year round with the construction—not the least reason for which is that such operation essentially requires some 150 feet of straightway for the rig to go between the two vertical supports and another 150 feet of straightway for coming out. Sitting there stationary with concrete footings, this type of snow removal apparatus is just in the way after the snow storm has passed, and serves no utilitarian purpose then whatsoever.
b. Secondly, the design of the plow whose blade contacts the snow on the roof is deficient. More specifically, being shaped as a wedge with two angled sections that extend from the center of the plow, two things happen—one, as the truck or trailer proceeds between the “I” beams, the snow essentially gets pushed rearwardly along the roof, building up more and more, and exerting an even greater force and pressure against the “I” beams as the operation continues; and two, the build-up of snow gets higher and higher as this progresses, and flows over the top of the snow plow, back onto that portion of the roof of the truck or trailer which has already passed. In other words, the wedge-shaped configuration does an inadequate job of removal, especially for those areas of the country which experience large and heavy snow falls. Moreover, the pushing of the snow off the back of the roof in this manner necessitates an entire snow plowing of the lane by a following vehicle before another rig can pass through.
c. Thirdly, a separate source of electrical power is required to operate the winch in raising or lowering the plow. As the patent points out, some type of conventional control station is needed for providing the electricity to operate the winch to adjust the plow height.

### SUMMARY OF THE INVENTION

As will become clear from the following description, the apparatus of the present invention comprises a fabricated, portable screed steel structure which can be easily moved with two fork lifts to place the structure in position when needed, and to remove it to a storage area when not in use—thereby freeing up the access lane at the truck terminal. As welded or bolted in being formed, the screed structure can be set up in less than one hour by two fork lifts operating in tandem to bring the structure into position, and by the placing of concrete blocks on top of its base plate as ballast to fix it. The adjustable plow which pushes off the snow accumulation, furthermore, is of an elongated-V configuration from side-to-side facing forwardly, so that as the truck or trailer proceeds through, the build-up is pushed off its sides, instead of primarily towards its back.

The raising and lowering of the elongated-V type plow is accomplished, additionally, by a boat winch operated from a 12 volt heavy duty truck battery. A control box and cable connector allows the winch operator to stand upwards of 30 feet and more away in viewing the snow clearing from the roof at many different angles to observe the adequacy of the plow operation. In such manner, the operator can determine whether the height of the plow should be adjusted upwardly or downwardly, and whether the wiper blade at the bottom of the plow is making sufficient contact with the roof, or whether the blade is bending too much from the force being applied. By being able to stand this distance away, the one operator needed for the snow removal is also able to be in position to communicate with the driver of the truck in directing what speed to travel at and when to start and stop. With the elongated-V shaped plow pushing the snow sideways from off the roof, less effort is required of a following vehicle to plow the lane free for the next rig to pass through in having its roof cleared of the snow build-up before entering onto a street or highway, and complying with Department of Transportation regulations as to roof snow removal.

### BRIEF DESCRIPTION OF THE DRAWINGS

These and other features of the present invention will be more clearly understood from a consideration of the following description, taken in connection with the accompanying drawings in which:

FIG. 1 is a pictorial view of the truck terminal snow screed of the invention as it would appear ready for the removal of snow. from the roofs of trucks and tractor trailers;

FIG. 2 is a front view of the snow screed, a rear view being a mirror image;

FIG. 3 is a left side view of the snow screed frame, a right side view likewise being a mirror image; and

FIG. 4 is a top view of the truck terminal snow screed of the invention.

### DETAILED DESCRIPTION OF THE INVENTION

As with the snow remover of U.S. Pat. No. 5,802,654, the truck terminal snow screed 10 of the invention includes two vertical supports 12, 14 separated by a distance sufficient to move truck and tractor trailer vehicles between the supports. Also as in the construction of U.S. Pat. No. 5,802,654 the snow screed 10 includes a snow plow 16 attached to the vertical supports 12, 14 located at a height which permits the vehicles to be moved under the plow while snow on the roofs of the vehicles is pushed off the vehicles. Additionally, as with that patent, the snow plow 16 is attached to the vertical supports by moving means which permit the plow 16 to be adjusted vertically along the supports 12, 14. As will become clear from the following description, however, the differences which exist between the snow remover of the present invention as compared to that of U.S. Pat. No. 5,802,653 allow for less effort in the snow build-up removal, and a freeing of an additional truck terminal lane for vehicle access for substantially all occasions when a moderate to heavy snow has not fallen.

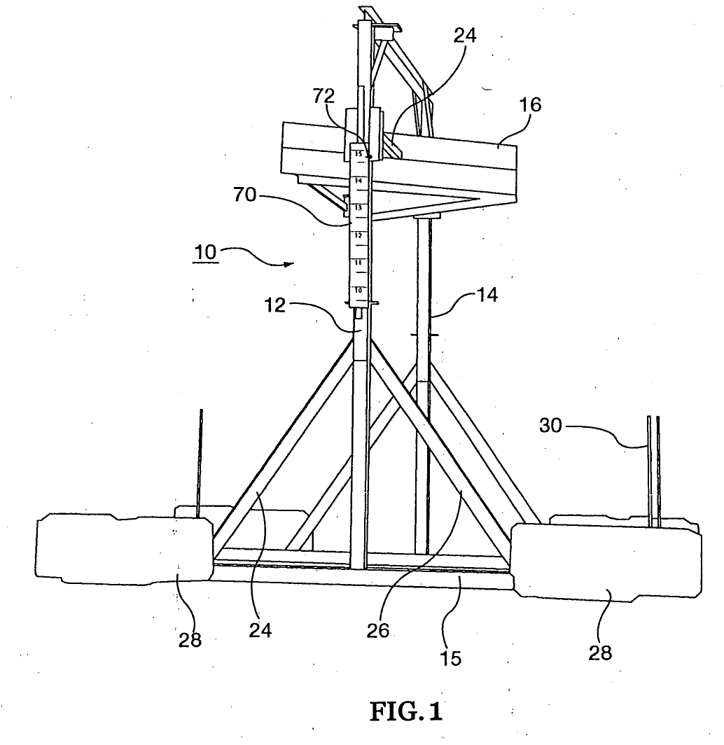

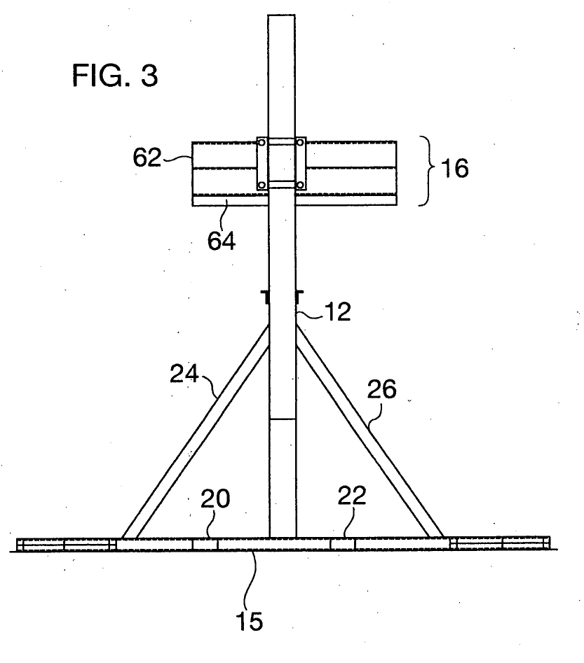

More specifically, and in accordance with one aspect of the invention, the truck terminal snow screed structure 10 comprises a fabricated steel frame of I-beams having first and second pockets 20, 22 on base plates 15 to be raised by two fork lifts operating in tandem in moving the frame into position for the trucks and tractor trailers to then pass through. As will be appreciated and understood, safety chains may be incorporated among the frame and forklift to prevent the frame from sliding off while it is being moved, along with a further “stiff pole” (not shown) bolted between the two side sections so they do not separate if one forklift should pull more than the other—and with the pole then being removed once the frame is properly placed in the lane so as not to block passage of the vehicles which then go through. As will be understood, one set of forks goes in the pockets 20, 22 on each side—and moving into position, one forklift backs up, and one goes forward. With the forks of these lifts being commonly 4 feet apart, the pockets 20, 22 may be located some 2 feet on either side of the lower portion of the vertical supports 12, 14. As FIGS. 1 and 3 illustrate, for support and strengthening, the lower portions of the vertical beams 12 and 14 are welded or bolted in a “delta” configuration with the base plate 15, by knee braces 24, 26.

To fix the frame and hold it steady once in position, one or more concrete blocks 28 are employed as ballast. To such end, the base plate I-beams 15 are of a length which extends beyond the “delta” configuration for receiving the concrete blocks moved by the forklifts by the handle grips 30 (with the blocks 28 weighing approximately 3 tons each). The screed frame structure 10 in one construction of the invention weighed some 8,800 pounds, and two forklifts with capacities of 5,000 pounds each operating in tandem were able to move the screed 10 into position and set it up, or remove it. This, of course, is not possible with the snow remover of U.S. Pat. No. 5,802,654 where its vertical supports are permanently embedded into the ground.

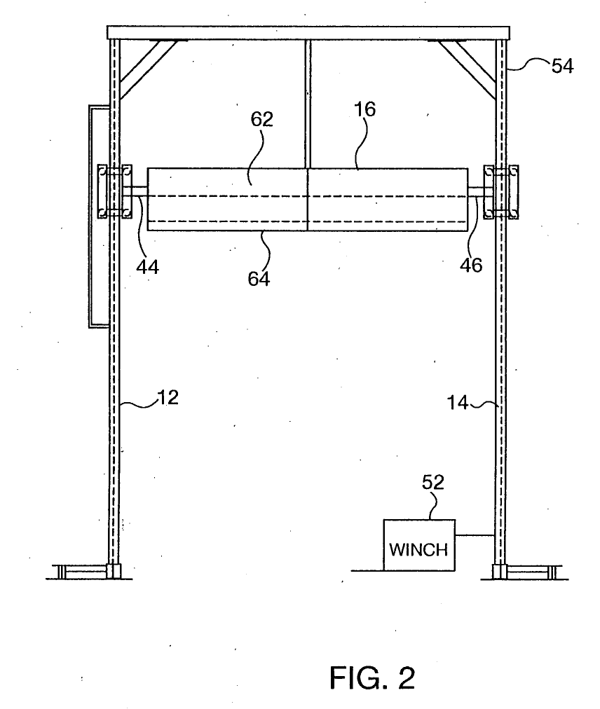

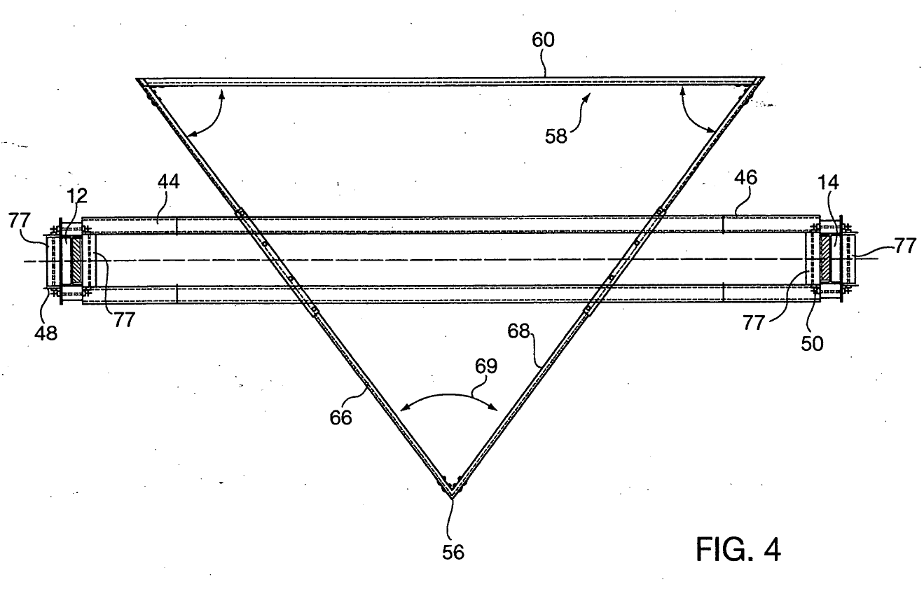

Additionally, and in accordance with the invention, an elongated-V configuration snow plow 16 is employed, angled from side-to-side instead of merely a wedge as in the plow of the 5,802,654 patent. As shown in FIGS. 1, 2 and 4, the plow 16 couples to be raised and lowered by first and second crossbars 44, 46 which extend from a pair of brackets 48, 50 on individual ones of the vertical supports 12, 14. As FIGS. 1 and 4 more specifically show, the elongated-V type plow 16 is angled forwardly toward the vehicles to meet substantially one-half way between the supports 12, 14. A boat winch 52 and a counter-weighted chain assembly 54 serve to raise and lower the plow 16. As FIG. 4 illustrates, the crossbars 44, 46 extend to the opposing side surface of the elongated-V angled snow plow 16 at a point substantially one-half way back from the nose end 56 of the plow 16. At the tail end 58 of the elongated-V angled plow 16, a third crossbar 60 extends. A roller and shaft assembly 77 wraps around each side of the vertical supports 12 and 14 to reduce any tendency for the plow 16 to bind up when being raised and lowered—as frequently occurred with the 5,802,654 patented construction.

With an upper portion 62 of the snow plow 16 being constructed of a structural steel material, a lower portion 64 may be composed of a neoprene rubber material to serve as a wiper blade, and to protect the roof of the truck or tractor trailer passing beneath. With the upper and lower portions bolted or otherwise secured together, the elongated-V angled snow plow 16, in a preferred embodiment, extends forwardly of the vertical supports 12, 14, a distance of substantially 4′6″. The elongated-V angled snow plow 16 extends rearwardly of the supports 12, 14, in this embodiment, a distance of substantially 3′6″. The angle formed by the opposing side surfaces 66, 68 of the elongated-V angled snow plow 16 is shown at 69 (of some 74°)—and with the opposing side surfaces 66, 68 being of a length of substantially 10 feet each, moving the truck or tractor trailer beneath the plow effectively forces the snow build-up off both its sides instead of rearwardly along the roof of the vehicle as with the construction of the 5,802,654 patented design. Less force is thus presented on the wiper blade 64 as it is moved from front-to-back of the roof—thereby extending the plow's useful life—and there is much less of a tendency for any heavy snow build-up to traverse over the top of the plow as the snow-clearing process continues. As will be appreciated by those skilled in the art, this, more readily, allow the operation to comply with and satisfy Department of Transportation regulations concerning the removal of snow from trucks and tractor trailers entering the roads and highways.

In accordance with the invention, the elongated-V angled snow plow 16 is constructed of a height chosen between 15 and 30 inches along its length, with the upper blade 64 being some 8 inches in height bolted to the upper portion 62 to extend some 4 inches below. A ¾ inch width has been found sufficient for the wiper blade 64 to adequately clear snow build-up, and by bolting the blade 64 to the upper portion 62, further allows for its being reversed in orientation as the lower portion extent of it contacting the roof wears, so that it may be inverted in direction. As will be understood by those skilled in the art, “V-angling” the snow off the sides of the vehicle roofs not only lessens the force exerted on the plow as the vehicle moves forwardly, but equally serves in keeping the access lane freer of snow for a following truck or tractor trailer. For “low-to-moderate” snow areas, a 15 inch height for the plow may suffice—white for “moderate-to-high” snow areas, a greater height may be required so that the snow does not back over the top of the plow as the vehicle proceeds forward.

The truck terminal snow screed of the invention further distinguishes from that of U.S. Pat. No. 5,802,654 by the employment of the slow-moving boat winch 52 with a 12 volt heavy duty truck battery for raising and lowering the elongated-V type plow 16. Rather than having to tie into a conventional control station for providing the electricity to operate the winch of that patent's teaching, utilizing a boat winch and a truck battery in this manner allows its operator to adjust the height of the plow by a simple control box and cable connection. This enables an operator to stand upwards of 30 feet and more away in viewing the snow clearing operation from different positions in monitoring the plow operation, and also enables an operator to stand nearer the driver of the truck or trailer in advising him/her when to start, when to stop, and at what speed to travel at.

To further facilitate observing the operation of the wiper blade 64 and monitoring its effectiveness, a height gauge 70 is mounted on one of the vertical supports (12 in FIG. 1), marked off in 6 inch intervals to correspond with the different heights of the vehicle roofs from off the ground, as displayed on the vehicle's body. A needle pointer 72 is fixed with the bracket 48, and set so that the bottom edge of the wiper blade 64 is in alignment with the vehicle roof. By having the cable connection to the truck battery, the winch operator is able to stand far enough away to determine whether the wiper blade 64 is making sufficient contact, or whether it is bending too much from the force being applied because of improper height setting. FIG. 1 illustrates the raising of the plow to a height such that the bottom-edge of the wiper blade 64 is at 13′6″, the roof height of approximately 90% of the trailers on the road today.

In accordance with the invention, then, a fabricated, portable steel structure is provided for screeding the roofs of trucks and tractor trailers of snow build-up. The screed structure can be easily moved with a pair of forklifts for placement in a storage area when not needed for use, and can be set up in less than one hour in the truck terminal access or exit lane. Once set up, only a single operator is required for controlling the operation, and only one piece of conventional snow removal equipment is needed to remove the build-up pushed off the sides from the roof before the next truck or tractor trailer is presented. As the vehicle passes underneath, the plow with the neoprene rubber wiper is adjusted to the proper height, controllable by the operator as needed to best effectuate the snow build-up removal. No field welding, use of concrete footings, or any special preparation is necessary before everything can be put in place for use.

While there have been described what are considered to be to be preferred embodiments of the present invention, it will be readily appreciated by those skilled in the art that modifications can be made without departing from the scope of the teachings herein. For at least such reason, therefore, resort-should be had to the claims appended hereto for a true understanding of the scope of the invention.

I claim:

1. A snow remover for truck and trailer vehicles comprising:
two vertical supports separated by a distance sufficient to move the vehicles between the vertical supports;
a cross piece attached to the vertical supports at their top portions and spanning the distance separating the vertical supports; and
a snow plow attached to the vertical supports and located at a height which permits the vehicles to be moved under the snow plow while snow on the roof of the vehicles is pushed off the vehicles;
wherein the snow plow is attached to the vertical supports by moving means which permit the snow plow to be adjusted vertically along the vertical supports;
first and second base plates connected to the vertical supports at their lower portions;
and means cooperating with the first and second base plates for lifting the base plates simultaneously in moving the snow remover from place-to-place.

2. The snow remover of claim 1 wherein the lifting means includes a pair of pockets in each of the first and second base plates on either side of the vertical supports connected thereto.

3. The snow remover of claim 2 wherein the pair of pockets are spaced substantially 2 feet on either side of the vertical supports.

4. The snow remover of claim 2 wherein each base plate includes an outward extension at their opposite ends for receiving ballast weights placed thereon once the snow remover is moved into position.

5. The snow remover of claim 4, including one or more concrete blocks placed atop the outward extension of the base plates.

6. The snow remover of claim 2, including first and second knee braces angularly connected to the vertical supports on one end and to the base plates at an opposite end.

7. The snow remover of claim 2 wherein the moving means includes a pair of brackets positionally adjustable on individual ones of the vertical supports, and first and second crossbars respectively extending from the brackets to opposing side surfaces of the snow plow.

8. The snow remover of claim 7 wherein the snow plow is in the configuration of an elongated-V from side-to-side angled forwardly toward the vehicles to meet substantially one half way between the two vertical supports, and with at least a lower portion of the snow plow being of a material which will not damage the roofs of the vehicles when brought into contact therewith.

9. The snow remover of claim 8 wherein the first and second crossbars extend to opposing side surfaces of the elongated-V side-to-side angled snow plow.

10. The snow remover of claim 7, including a height gauge outwardly extending from one of the vertical supports, with a pointer on its positioning adjustable bracket movable with the bracket.
